(19) United States
(12) Patent Application Publication
(10) Pub. No.: US 2023/0185859 A1
(43) Pub. Date: Jun. 15, 2023

(54) DOCUMENT MANAGEMENT DEVICE, DOCUMENT MANAGEMENT METHOD, AND NON-TRANSITORY RECORDING MEDIUM

(71) Applicant: TOSHIBA TEC KABUSHIKI KAISHA, Tokyo (JP)

(72) Inventor: Kouichirou NISHI, Sunto Shizuoka (JP)

(73) Assignee: TOSHIBA TEC KABUSHIKI KAISHA, Tokyo (JP)

(21) Appl. No.: 17/549,060

(22) Filed: Dec. 13, 2021

(51) Int. Cl. G06F 16/93; G06F 16/11; G06F 9/54

(52) U.S. Cl. CPC G06F 16/93; G06F 16/116; G06F 9/542

(57) ABSTRACT

A document management device includes a memory and a controller. The memory stores one or more format files, the one or more format files including a first format file. The controller is configured to (a) receive a second format file that is based on at least one of the one or more format files, (b) determine if the first format file stored in the memory is older than the second format file, (c) identify a destination for a notification based on document information associated with the first format file, and (d) provide the notification to the destination if the first format file is older than the second format file, the notification indicating the first format file as being old.

### FIELD

Embodiments described herein relate generally to a document management device, a document management method, and a non-transitory recording medium.

### BACKGROUND

In the related art, a created document is generally stored in a database or the like, and may be viewed or modified in a place to be changed. However, a format of the created document may not be updated (e.g., to a desired format).

### DESCRIPTION OF THE DRAWINGS

FIG. 1 is a diagram illustrating a configuration of a document management system according to an embodiment;

FIG. 2 is a block diagram illustrating a hardware configuration of a user device;

FIG. 3 is a block diagram illustrating a hardware configuration of a document management device;

FIG. 4 is a diagram illustrating an example of a user information table;

FIG. 5 is a flowchart illustrating a flow of a format file new registration process performed by the document management device;

FIG. 6 is a sequence diagram illustrating a flow of a format file update process performed by the document management system; and

FIG. 7 is a sequence diagram illustrating a flow of a document registration process performed by the document management system.

### DETAILED DESCRIPTION

A document management device according to an embodiment includes a memory and a controller. The memory stores one or more format files, the one or more format files including a first format file. The controller is configured to (a) receive a second format file that is based on at least one of the one or more format files, (b) determine if the first format file stored in the memory is older than the second format file, (c) identify a destination for a notification based on document information associated with the first format file, and (d) provide the notification to the destination if the first format file is older than the second format file, the notification indicating the first format file as being old.

Hereinafter, a document management device, a document management method, and a non-transitory recording medium according to embodiments will be described with reference to the drawings.

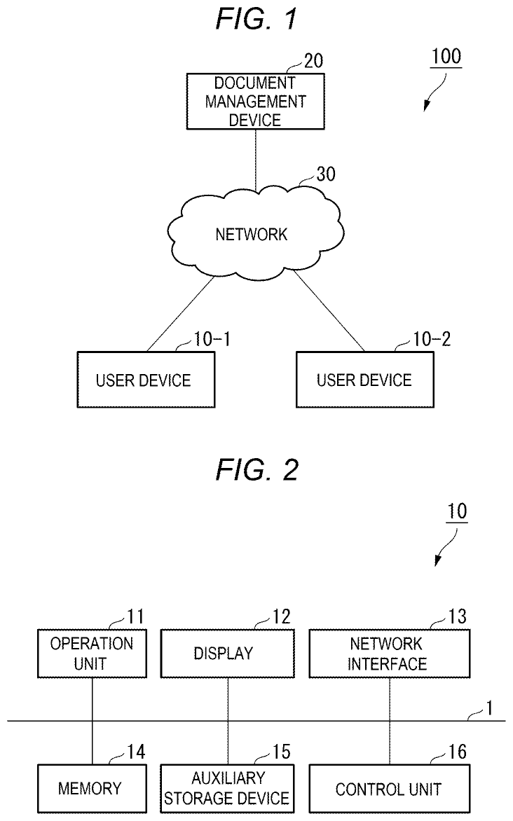

FIG. 1 is a diagram illustrating a configuration of a document management system 100 according to the embodiment. The document management system 100 includes user devices 10-1 and 10-2 (e.g., smartphones, personal computers, notebook computers, laptop computers, desktop computers, tablets, point of sale kiosks, etc.) and a document management device 20 (e.g., a server, a remote storage device, a cloud device, etc.). The user devices 10-1 and 10-2 and the document management device 20 are communicably connected to each other via a network 30. The network 30 may be a network configured in any way. For example, the network 30 is a network such as a wireless local area network (LAN). When the user devices 10-1 and 10-2 are not particularly distinguished, they are simply described as a user device 10.

In the document management system 100, a user operates the user device 10 to store a format file in the document management device 20. Then, when the user creates a document using the format file stored in the document management device 20 and stores the document in the document management device 20, the document management device 20 confirms whether a format of the created document is a latest file, and notifies the user device 10 if the format is old. For example, the document management device 20 notifies a creator stored in property information of the document.

The user device 10 is operated by, for example, a user who registers a format file or a user who creates a document using the format file. In the following description, it is assumed that a user who operates the user device 10-1 is the user who registers the format file, and a user who operates the user device 10-2 is the user who creates the document using the format file. The user device 10 registers the format file or registers the document created by using the format file in the document management device 20 according to an operation of the user. The user device 10 is configured by using an information processing device such as a personal computer, a notebook computer, a tablet terminal, or a smartphone.

When the format file is stored, the document management device 20 analyzes a file name of the format file and stores the file name, version information, and ID information in properties. The document management device 20 further stores property information of the format file. When a document is created using the format file and registered from the user device 10, the document management device 20 confirms property information of the registered document, and notifies the user device 10 if the document is not the latest version. The document management device 20 is configured by using an information processing device such as a personal computer.

FIG. 2 is a block diagram illustrating a hardware configuration of the user device 10. The user device 10 includes an operation unit 11, a display 12, a network interface 13, a memory 14, an auxiliary storage device 15, and a control unit 16. The functional units are connected to enable data communication via a system bus 1.

The operation unit 11 (e.g., an input device, an input portion of a user interface) accepts an operation (e.g., an input) of the user. The operation unit 11 outputs a signal corresponding to the operation performed by the user to the control unit 16. The operation unit 11 and the display 12 may be configured as an integrated touch panel.

The display 12 (e.g., an output device, an output portion of a user interface) is an image display device such as a liquid crystal display or an organic electro luminescence (EL) display. The display 12 displays various pieces of information about the user device 10. The display 12 outputs the signal corresponding to the operation performed by the user to the control unit 16.

The network interface 13 transmits or receives data to or from the other device. Here, the other device is, for example, the document management device 20. The network interface 13 operates as an input interface and receives data or instructions transmitted from the other device. The network interface 13 operates as an output interface and transmits the format file or the document created by using the format file to the other device.

The memory 14 temporarily stores data used by the functional units included in the user device 10. The memory 14 is, for example, a random access memory (RAM).

The auxiliary storage device 15 is, for example, a hard disk or a solid state drive (SSD), and stores various data. The various data include, for example, digital data, jobs, and job logs.

The control unit 16 (e.g., a controller) is a processor (e.g., one or more processors) such as a central processing unit (CPU) or a graphics processing unit (GPU). The control unit 16 controls operations of the functional units of the user device 10. The control unit 16 executes various processes by loading a program stored in a read only memory (ROM) into the RAM and executing the program. An application specific integrated circuit (ASIC) may have an appropriate function implemented by the control unit 16. The ASIC is a dedicated circuit for implementing a specific function.

Here, an example of the processes of the control unit 16 is described. The control unit 16 creates the document using the format file according to the operation of the user.

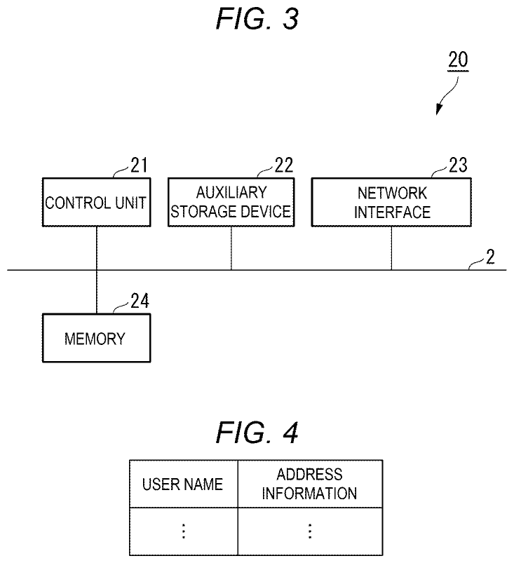

FIG. 3 is a block diagram illustrating a hardware configuration of the document management device 20. The document management device 20 includes a control unit 21, an auxiliary storage device 22, a network interface 23, and a memory 24. The functional units are connected to enable data communication via a system bus 2.

The control unit 21 (e.g., a controller) is a processor (e.g., one or more processors) such as CPU or GPU. The control unit 21 controls operations of the functional units of the document management device 20. The control unit 21 executes various processes by loading a program stored in the ROM or the auxiliary storage device 22 into the RAM and executing the program. The ASIC may have an appropriate function implemented by the control unit 21. The ASIC is a dedicated circuit for implementing a specific function.

Here, an example of the processes of the control unit 21 is described. When a document is registered from the user device 10, the control unit 21 confirms the property information of the registered document and determines whether the document is the latest version. As a result of the determination, if the document is not the latest version, the control unit 21 notifies the user device 10 operated by the user who is a creator of the document. For example, the control unit 21 makes a notification of information indicating that the format of the document may be old.

The auxiliary storage device 22 (e.g., a storage or memory) is, for example, a hard disk or a solid state drive (SSD), and stores various data. The various data include, for example, a user information table and a document management table. The user information table is a table in which information about a user who operates the user device 10 is registered. The document management table is a table in which information about the registered format file is registered (e.g., one or more keywords, searchable identification information, document information, etc.). For example, in the document management table, a format ID, version information, and data of the format file are associated with each other. The document information may be used to identify each of the format files.

FIG. 4 is a diagram illustrating an example of the user information table. As illustrated in FIG. 4, the user information table is configured with a plurality of records in which a user name and address information are associated with each other. The user name is a name of the user who operates the user device 10. For example, the user name is registered in the user device 10, and when a document is created, a name of a last updater of the document is a registered user name. Accordingly, the user who created the document can be specified. The address information is information for communicating with the user device 10, and includes, for example, an e-mail address.

Returning to FIG. 3, the description of the document management device 20 will be continued. The network interface 23 transmits or receives data to or from the other device. The network interface 23 operates as an input interface and receives a format file and a document transmitted from the other device. The network interface 23 operates as an output interface and transmits data to the other device. The network interface 23 is an example of a communication unit.

The memory 24 is, for example, a RAM. The memory 24 temporarily stores data used by the functional units included in the document management device 20. The memory 24 may temporarily store the jobs and the job logs.

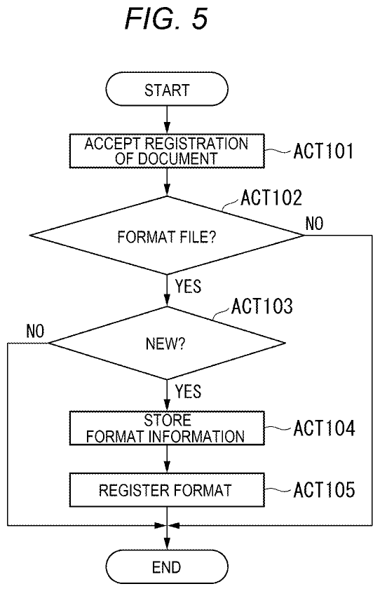

FIG. 5 is a flowchart illustrating a flow of a format file new registration process (e.g., a new registration process for a format file) performed by the document management device 20. The document management device 20 accepts registration of a document (ACT 101). When the document is registered from the user device 10, the control unit 21 determines whether the registered document is a format file (ACT 102). Whether the document is a format file is determined based on analysis of the document and whether information indicating that the document is a format file (for example, is Format) is stored in the document.

When the information indicating that the document is the format file is stored in the document, the control unit 21 determines that the document is the format file. Meanwhile, when the information indicating that the document is the format file is not stored in the document, the control unit 21 determines that the document is not the format file. If the document is not the format file (ACT 102: NO), the document management device 20 ends the process in FIG. 5.

If the document is the format file (ACT 102: YES), the control unit 21 determines whether the registered document is a new format file (ACT 103). Whether the file is a new format file is determined based on whether a format ID of the document is registered in the auxiliary storage device 22. When the format ID of the document is already registered in the auxiliary storage device 22, the control unit 21 determines that the registered document is not the new format file. When the format ID of the document is not registered in the auxiliary storage device 22, the control unit 21 determines that the registered document is the new format file.

If the registered document is the new format file (ACT 103: YES), the control unit 21 stores the format information in the document (ACT 104). Specifically, the control unit 21 stores the format ID, the version information, and the file name included in the registered document in the properties (e.g., a properties section) of the document. Then, the control unit 21 registers the format ID, the version information, and the document data in the document management table (ACT 105).

In the process of ACT 103, if the registered document is not the new format file (ACT 103: NO), the document management device 20 ends the process in FIG. 5.

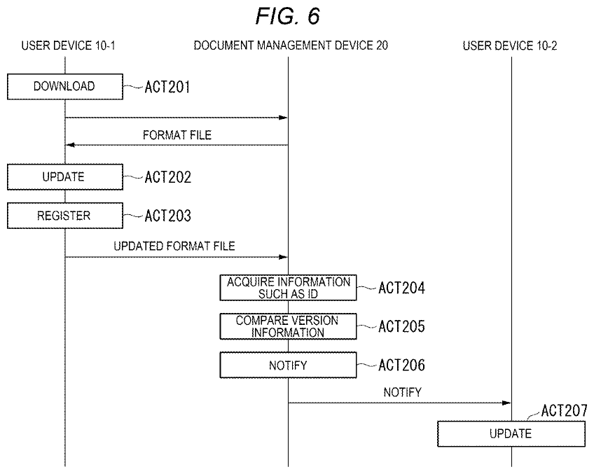

FIG. 6 is a sequence diagram illustrating a flow of a format file update process performed by the document management system 100. The user operates the user device 10-1 to download a format file to be updated from the document management device 20 (ACT 201). In this process, the user operates the user device 10-1 to request a format file from the document management device 20, and the document management device 20 presents all the format files stored in the document management table to the user device 10-1 for selection.

Here, it is assumed that the user downloads a format file in which the user of the user device 10-2 is the creator. The user updates the format file downloaded from the document management device 20 by operating the user device 10-1 (ACT 202). Accordingly, a version of the downloaded format file is updated.

The user operates the user device 10-1 to register the updated format file in the document management device 20 (ACT 203). The network interface 23 of the document management device 20 receives the format file transmitted from the user device 10-1. The network interface 23 outputs the received format file to the control unit 21. The control unit 21 acquires a format ID and version information of the acquired format file (ACT 204).

The control unit 21 refers to the document management table stored in the auxiliary storage device 22 and acquires (e.g., locates) a format file corresponding to the acquired format ID. The control unit 21 compares version information of the acquired format file (e.g., version information of the format file that was previously stored in the auxiliary storage device 22) with the version information of the format file acquired from the user device 10-1 (e.g., version information of the format file that the user is attempting to register) (ACT 205).

If the version information of the acquired format file is the same as or newer than the version information of the format file acquired from the user device 10-1 (i.e., the format file previously stored in the auxiliary storage device 22 is the same version or a newer version than the format file that the user is attempting to register), the control unit 21 does not perform any particular process.

If the version information of the acquired format file is older than the version information of the format file acquired from the user device 10-1 (i.e., the format file previously stored in the auxiliary storage device is an older version than the format file that the user is attempting to register), the control unit 21 performs the following process. Specifically, first, the control unit 21 acquires information of the creator of the format file stored in the auxiliary storage device 22. Next, the control unit 21 refers to the user name in the user information table and acquires the record corresponding to the acquired creator. The control unit 21 acquires a value registered in an item of address information of the acquired record.

The control unit 21 controls the network interface 23 and notifies the user device 10-2 of the acquired address information. For example, the control unit 21 controls the network interface 23 to transmit a new format file and a notification including a possibility that the format is old to the user device 10-2 (ACT 206).

The network interface 13 of the user device 10-2 receives the notification transmitted from the document management device 20. The network interface 13 outputs the received notification to the control unit 16. The control unit 16 displays the output notification on the display 12. Accordingly, the user of the user device 10-2 can understand that the version of the format file registered in the document management device 20 is old. The user of the user device 10-2 updates the format file by registering the new format file included in the notification in the document management device 20 (ACT 207).

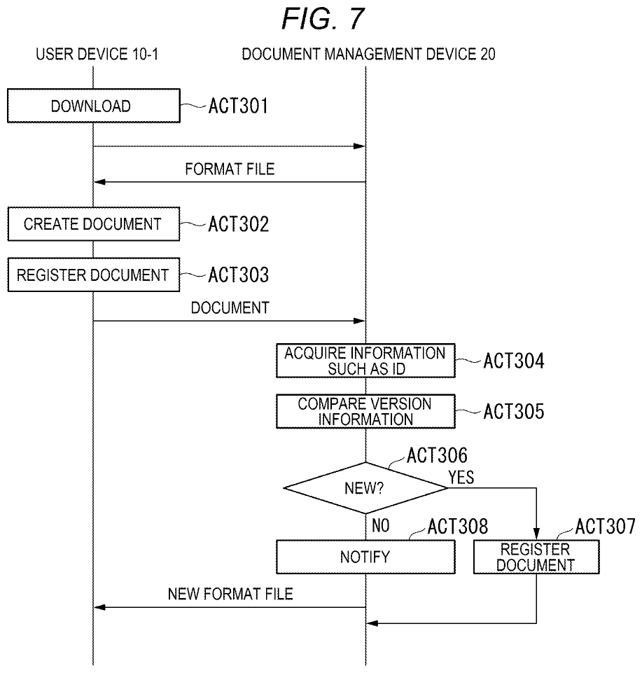

FIG. 7 is a sequence diagram illustrating a flow of a document registration process performed by the document management system 100. The user operates the user device 10-1 to download a format file used for creating the document from the document management device 20 (ACT 301). The user creates a document using the format file downloaded from the document management device 20 (ACT 302).

The user operates the user device 10-1 and registers the created document in the document management device 20 (ACT 303). The network interface 23 of the document management device 20 receives the document transmitted from the user device 10-1. The network interface 23 outputs the received document to the control unit 21. The control unit 21 acquires a format ID and version information of the obtained document (ACT 304).

The control unit 21 refers to the acquired format file stored in the auxiliary storage device 22 and acquires a format file corresponding to the acquired format ID. The control unit 21 compares version information of the acquired format file with the version information of the document acquired from the user device 10-1 (ACT 305).

As a result of the comparison, the control unit 21 determines whether the version information of the document acquired from the user device 10-1 is new (ACT 306). When the version information of the document acquired from the user device 10-1 is the same as or newer than the version information of the acquired format file, the control unit 21 determines that the version information of the document acquired from the user device 10-1 is new.

When the version information of the document acquired from the user device 10-1 is older than the version information of the acquired format file, the control unit 21 determines that the version information of the document acquired from the user device 10-1 is not new (e.g., is not a latest version, is not a newest version). If the version information of the document acquired from the user device 10-1 is new (e.g., is a latest version, is a newest version) (ACT 306: YES), the control unit 21 registers the document in the auxiliary storage device 22.

If the version information of the document acquired from the user device 10-1 is not new (ACT 306: NO), the control unit 21 controls the network interface 23 to notify (e.g., provide a notification to) the user device 10-1 of a fact that the new format file is present (ACT 308). In this case, the control unit 21 may transmit the new format file to the user device 10-1.

According to the document management system 100 configured as described above, the document can be managed such that the format of the registered document is the latest version. Specifically, in the document management system 100, the document management device 20 refers to the version information of the registered format file or the document to confirm whether the version of the registered format file or the document is the latest version. If the version of the registered format file or the document is not the latest version, a notification is given. Accordingly, the latest version of the format file or the document is always stored in the document management device 20. Therefore, the document can be managed such that the format of the registered document is the latest version.

A part of the functions of the user device 10 and the document management device 20 in the above-described embodiment may be implemented by a computer. In this case, the program for implementing the functions is recorded on a computer-readable recording medium. A program recorded on the recording medium on which the above-mentioned program is recorded may be read into a computer system and executed. It should be noted that the “computer system” used herein includes hardware such as an operating system and a peripheral device. The “computer-readable recording medium” refers to a portable medium, a storage device, or the like. The portable medium is a flexible disk, a magneto-optical disk, a ROM, a CD-ROM, or the like. The storage device is a hard disk or the like built in the computer system.

The “computer-readable recording medium” is a medium that dynamically holds a program for a short period of time, like a communication line when a program is transmitted via the communication line. The communication line is a network such as the Internet, a telephone line, or the like. The “computer-readable recording medium” may be a volatile memory inside the computer system that serves as a server or a client. The volatile memory holds a program for a certain period of time. The program may be used to implement a part of the functions. The program may further implement the functions in combination with a program already recorded in the computer system.

While certain embodiments have been described, these embodiments have been presented by way of example only, and are not intended to limit the scope of the disclosures. Indeed, the novel embodiments described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A document management device, comprising:
a memory configured to store one or more format files, the one or more format files including a first format file; and
a controller configured to:
receive a second format file that is based on at least one of the one or more format files;
determine if the first format file stored in the memory is older than the second format file;
identify a destination for a notification based on document information associated with the first format file; and
provide the notification to the destination if the first format file is older than the second format file, the notification indicating the first format file as being old.

2. The document management device of claim 1, wherein the document information is first document information and the controller is configured to:
store the one or more format files in the memory; and
store document information in the memory associated with each of the one or more format files.

3. The document management device of claim 2, wherein the document information includes at least a format ID for each of the one or more format files and version information for each of the one or more format files.

4. The document management device of claim 2, wherein the controller is configured to store the document information in a properties section of the corresponding one of the one or more format files.

5. The document management device of claim 1, wherein the controller is configured to identify the first format file within the memory based on a format ID of the second format file.

6. The document management device of claim 1, wherein the controller is configured to:
compare version information of the first format file with version information of the second format file; and
provide the notification indicating the first format file as being old if the version information of the second format file is newer than the version information of the first format file.

7. The document management device of claim 1, wherein the notification is a first notification, and the controller is configured to:
receive a document generated using any of the one or more format files;
determine if a format of the document is a newest format; and
provide a second notification to a user device associated with a creator of the document in response to a determination that the format of the document is not the newest format, the second notification indicating that the format of the document is not the newest format.

8. The document management device of claim 1, wherein the destination for the notification is a user device associated with a creator of the first format file.

9. The document management device of claim 1, wherein the destination for the notification is a user device that most recently updated the first format file.

10. A document management method, comprising:
storing one or more format files in a memory, the one or more format files including a first format file;
receiving a second format file that is based on at least one of the one or more format files;
determining if the first format file stored in the memory is older than the second format file;
identifying a destination for a notification based on document information associated with the first format file; and
providing the notification to the destination if the first format file is older than the second format file, the notification indicating the first format file as being old.

11. The document management method of claim 10, wherein the document information is first document information, the document management method further comprising:
storing document information in the memory associated with each of the one or more format files.

12. The document management method of claim 11, wherein the document information includes at least a format ID for each of the one or more format files and version information for each of the one or more format files.

13. The document management method of claim 11, wherein the document information is stored in a properties section of the corresponding one of the one or more format files.

14. The document management method of claim 10, further comprising identifying the first format file within the memory based on a format ID of the second format file.

15. The document management method of claim 10, wherein:
determining if the first format file is older than the second format file includes comparing version information of the first format file with version information of the second format file; and
providing the notification to the destination in response to the determination that the first format file is older than the second format file includes providing the notification if the version information of the second format file is newer than the version information of the first format file.

16. The document management method of claim 10, wherein the notification is a first notification and the document management method further comprises:
receiving a document generated using any of the one or more format files;
determining if a format of the document is a newest format; and
providing a second notification to a user device associated with a creator of the document in response to a determination that the format of the document is not the newest format, the second notification indicating that the format of the document is not the newest format.

17. The document management method of claim 10, wherein the destination for the notification is a user device associated with a creator of the first format file.

18. The document management method of claim 10, wherein the destination for the notification is a user device that most recently updated the first format file.

19. A non-transitory recording medium including instructions stored thereon that, when processed by at least one processor, cause the at least one processor to perform operations comprising:
storing one or more format files in a memory, the one or more format files including a first format file;
receiving a second format file that is based on at least one of the one or more format files;
determining if the first format file stored in the memory is older than the second format file;
identifying a destination for a notification based on document information associated with the first format file; and
providing the notification to the destination if the first format file is older than the second format file, the notification indicating the first format file as being old.

20. The non-transitory recording medium of claim 19, wherein the notification is a first notification and the operations further comprise:
receiving a document generated using any of the one or more format files;
determining if a format of the document is a newest format; and
providing a second notification to a user device associated with a creator of the document in response to a determination that the format of the document is not the newest format, the second notification indicating that the format of the document is not the newest format.
